(19) United States
(12) Patent Application Publication
(10) Pub. No.: US 2014/0264125 A1
(43) Pub. Date: Sep. 18, 2014

(54) THERMOPLASTIC OR ELASTOMERIC SINGLE USE HIGH PURITY FULL FLOW PINCH VALVE FOR BIOTECH APPLICATIONS

(71) Applicant: Del Fularon, Fort Lee, NJ (US)

(72) Inventor: Del Fularon, Fort Lee, NJ (US)

(21) Appl. No.: 13/843,929

(22) Filed: Mar. 15, 2013

(51) Int. Cl. F16K 3/30

(52) U.S. Cl. CPC F16K 3/30
USPC 251/309

(57) ABSTRACT

A thermoplastic or elastomeric single use high purity full flow pinch valve can be used for high purity applications, such as biotech applications. The valve mimics the performance of a traditional valve with the added feature of being able to be gamma irradiated at a cost that allows it to be discarded after a single use. The valve can be considered as a single use valve can be practically considered as completely disposable.

### BACKGROUND OF THE INVENTION

The present invention relates to valves and, more particularly, to a thermoplastic or elastomeric single use high purity full flow pinch valve for biotech applications.

For biotech processes, all product contact components, such as valves, tubing, filters, fittings, and the like, must be sterile. The most popular way to make these items sterile is to autoclave or gamma irradiate them. The irradiation method is cost effective with less risk to the users. Gamma sterilization requires non-metallic components with costs that allow them to be discarded after a production run or batch. There are, however, no valves of this type that would be considered single use or disposable.

Other valves can be designed for continuous use in a fixed piping process and can be autoclaved between runs or batches. These valves must be disassembled, autoclaved and reassembled with new elastomeric seals.

As can be seen, there is a need for a packless pinch valve that can be disposable and does not leak that can be used in high purity applications, such as applications present in food, dairy, cosmetic and pharmaceutical applications.

### SUMMARY OF THE INVENTION

In one aspect of the present invention, a valve assembly comprises a stem shaft; a handle disposed on one end of the stem shaft; a groove formed in a spiral about the stem shaft; an upper housing having an upper body port for receiving the stem shaft therein; first and second pins fitting through upper body ports formed on opposite sides of the upper body port, the first and second pins being disposed in the groove in the stem shaft; and a lower housing attached to the upper housing and having a channel formed through the upper housing and lower housing, wherein turning the handle moves the shaft between a first position, blocking flow through the valve, and a second position, allowing full flow through the valve.

In another aspect of the present invention, a valve assembly comprises a stem shaft; a handle disposed on one end of the stem shaft; a groove formed in a spiral about a single revolution of the stem shaft; an upper housing having an upper body port for receiving the stem shaft therein; first and second pins fitting through upper body ports formed on opposite sides of the upper body port, the first and second pins being disposed in the groove in the stem shaft; and a lower housing attached to the upper housing and having a channel formed through the upper housing and lower housing, wherein turning the handle moves the shaft between a first position, blocking flow through the valve, and a second position, allowing full flow through the valve, wherein the channel is shaped in an oval shape, being wider on sides of the channel than a height of the channel.

These and other features, aspects and advantages of the present invention will become better understood with reference to the following drawings, description and claims.

### BRIEF DESCRIPTION OF THE DRAWINGS

FIG. 1 is a perspective view of a high purity full flow pinch valve according to an exemplary embodiment of the present invention;

FIG. 2 is a side view of the high purity full flow pinch valve of FIG. 1;

FIG. 3 is a top view of the high purity full flow pinch valve of FIG. 1, illustrating turning of its valve handle;

FIG. 4 is an end view of the high purity full flow pinch valve of FIG. 1;

FIG. 5 is a cross-sectional view taken along line 5-5 of FIG. 1; and

FIG. 6 is an exploded perspective view of the high purity full flow pinch valve of FIG. 1.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a thermoplastic or elastomeric single use high purity full flow pinch valve for high purity applications, such as biotech applications. The valve mimics the performance of a traditional valve with the added feature of being able to be gamma irradiated at a cost that allows it to be discarded after a single use. The valve can be considered as a single use valve can be practically considered as completely disposable.

Referring now to FIGS. 1 through 6, a valve 10 can include a stem shaft 16 having a handle 18 disposed on one end thereof. A stem groove 14 can be cut as a spiral about the stem shaft 16. Typically, the stem groove 14 is cut about one revolution of the stem shaft 16, providing a valve where one full revolution of the handle 18 can move the application between a closed position and an open position.

The stem shaft 16 can fit into an upper body extrusion 26 of an upper body 24 of the valve 10. A pin 20 can be inserted into each side of the upper body 24, through upper body ports 28, so that the pin fits into the stem groove 14. The upper body ports 28 are disposed at different heights along the upper body extrusion 26 to align with the stem groove 14. Therefore, as the stem shaft 16 is rotated, the stem groove 14 moved along the pins 20, causing the stem shaft 16 to raise and lower in the upper body 24.

The upper body 24 can attach to a lower body 34 by various methods. As shown in FIG. 6, the upper body 24 can include side clip arms 30 on each side thereof, terminating in a side clip tooth ledge 32. The slide clip tooth ledge 32 can fit into the lower body 34 and be removably retained by the lower body 34.

A spool 22 can fit into a chamber formed by the upper body 24 and the lower body 34. This chamber can be formed in an oval shape by having the side walls of the upper body 24 and the lower body 34 to open outward. This oval shape can help pre-compress the tubing into the valve and can provide less travel between open and closed for the valve. The valve can be provided as an assembly with a spool 22 or tubing.

All components of the valve 10 can be made of a plastic material by injection molding, for example. The components can be increased or decreased in size to accommodate various sizes of tubing and spools.

The valve of the present invention can be used as a normal valve with the added ability to be gamma irradiated. The valve can also be discarded after use with a minimum cost penalty. The valve can also be assembled to longer spool sections, thus eliminating one process connection a conventional valve would need.

The valve, because of its low cost, can be used by any industry needing a packless valve (such as a pinch valve) and needing a valve that does not leak, such as those needed in high purity applications, including biotech, food, diary, cosmetics, pharmaceuticals, and like applications.

It should be understood, of course, that the foregoing relates to exemplary embodiments of the invention and that modifications may be made without departing from the spirit and scope of the invention as set forth in the following claims.

What is claimed is:

1. A valve assembly comprising:
a stem shaft;
a handle disposed on one end of the stem shaft;
a groove formed in a spiral about the stem shaft;
an upper housing having an upper body port for receiving the stem shaft therein;
first and second pins fitting through upper body ports formed on opposite sides of the upper body port, the first and second pins being disposed in the groove in the stem shaft; and
a lower housing attached to the upper housing and having a channel formed through the upper housing and lower housing, wherein turning the handle moves the shaft between a first position, blocking flow through the valve, and a second position, allowing full flow through the valve.

2. The valve assembly of claim 1, wherein the channel is shaped in an oval shape, being wider on sides of the channel than a height of the channel.

3. The valve assembly of claim 1, a spool disposed in the channel.

4. The valve assembly of claim 1, wherein all components of the valve assembly are made of plastic.

5. The valve assembly of claim 1, wherein the upper body is removable attached to the lower body.

6. The valve assembly of claim 1, further comprising upper body side clip arms extending from sides of the upper body; and upper body side clips on ends of the upper body side clip arms, wherein the upper body side clips attach to the lower body to retain the upper body to the lower body.

7. The valve assembly of claim 1, wherein the groove is formed about a single revolution of the stem shaft.

8. A valve assembly comprising:
a stem shaft;
a handle disposed on one end of the stem shaft;
a groove formed in a spiral about a single revolution of the stem shaft;
an upper housing having an upper body port for receiving the stem shaft therein;
first and second pins fitting through upper body ports formed on opposite sides of the upper body port, the first and second pins being disposed in the groove in the stem shaft; and
a lower housing attached to the upper housing and having a channel formed through the upper housing and lower housing, wherein turning the handle moves the shaft between a first position, blocking flow through the valve, and a second position, allowing full flow through the valve, wherein
the channel is shaped in an oval shape, being wider on sides of the channel than a height of the channel.

9. The valve assembly of claim 8, wherein all components of the valve assembly are made of plastic.

10. The valve assembly of claim 8, further comprising upper body side clip arms extending from sides of the upper body; and upper body side clips on ends of the upper body side clip arms, wherein the upper body side clips attach to the lower body to retain the upper body to the lower body.
